(19) United States
(12) Patent Application Publication
(10) Pub. No.: US 2018/0213937 A1
(43) Pub. Date: Aug. 2, 2018

(54) APPARATUS FOR IDENTIFYING A SEAT IN A VENUE

(71) Applicant: HUNTER SAUCEDO, LTD., Tupelo, MS (US)

(72) Inventors: Luis Saucedo, Williams Bay, WI (US); Marisa Saucedo, Williams Bay, WI (US)

(73) Assignee: HUNTER SAUCEDO, LTD., Tupelo, MS (US)

(21) Appl. No.: 15/418,769

(22) Filed: Jan. 29, 2017

(51) Int. Cl. A47C 1/13; A47C 7/72; G09F 13/04; G09F 13/08; G09F 23/00

(52) U.S. Cl. CPC A47C 1/13; A47C 7/725; G09F 2013/222; G09F 13/08; G09F 23/00; G09F 13/0413

(57) ABSTRACT

An apparatus for identifying a seat in a venue is disclosed. The apparatus includes a cylindrical base having an open end and a sidewall defining a hollow interior in which a printed circuit board is supported. The printed circuit board has at least one light-emitting diode and a voltage regulator configured for providing power to the diode. An identification component having visual indicia for identifying the seat within the venue is used. The identification component includes a second set of one or more engagement structures that are configured to mate with the first set of one or more engagement structures so that the identification component may be releasably secured to the cylindrical base. The visual indicia of the identification component is translucent and positioned for illumination by the at least one light-emitting diode when the identification component is secured to the cylindrical base.

### FIELD

The present disclosure relates to apparatus used to identify a location of a fixture within a venue and, more particularly, to a seat marker for identifying a seat within the venue.

### BACKGROUND

Venues, such as theaters, sporting arenas, and other places accessible to the public, include many seating locations. In many instances, patrons purchase tickets for specific seats or seat sections.

Specific indicia types may be used to identify the seat or section to the patron. In some environments, particularly in low-lit venues, the markers may be illuminated. Illuminated markers, however, may be difficult to implement and install. The construction of the marker itself may be complicated and costly to make. Provision of power to the illuminating element of the marker also presents significant challenges.

### SUMMARY

An apparatus for identifying a seat in a venue is disclosed. One general aspect of the apparatus includes a cylindrical base having an open end and a sidewall defining a hollow interior, where the cylindrical base is configured for securement within an opening of a seat. The cylindrical base also includes a first set of one or more engagement structures. A printed circuit board is supported in the hollow interior of the cylindrical base and has at least one light-emitting diode. The printed circuit board includes a voltage regulator configured for providing power to the at least one light-emitting diode. An identification component having visual indicia for identifying the seat within the venue is also provided. The identification component has a second set of one or more engagement structures configured to mate with the first set of one or more engagement structures of the cylindrical base, where the first set of one or more engagement structures and second set of one or more engagement structures are configured to releasably secure the identification component to the cylindrical base. The visual indicia of the identification component is translucent and positioned for illumination by the at least one light-emitting diode when the identification component is secured to the cylindrical base.

The apparatus may be implemented to include various features. For example, the apparatus may include a power cable assembly configured to provide power from a power bus to the printed circuit board, where the power bus is used to provide power to multiple seats of the venue, such as may be provided to seat adjustment systems in the multiple seats of the venue. The printed circuit board may include a light-emitting diode and a voltage regulator electrically connected between the power cable assembly and the light-emitting diode.

The engagement structures may be implemented so that the first set of one or more engagement structures and second set of one or more engagement structures engage one another in a cantilever snap fit arrangement. Additionally, or alternatively, the first set of one or more engagement structures and second set of one or more engagement structures may be configured to form a clip lock fitting arrangement.

Another general aspect of the disclosure includes an apparatus for identifying a seat location in a venue, where the apparatus includes a cylindrical body having an open end and a sidewall defining a hollow interior. A printed circuit board is supported in the hollow interior and has at least one lighting element. A flange is secured with the cylindrical body and substantially surrounds the open end. The flange is configured to secure the cylindrical body within an opening of a fixed object located proximate the seat location in the venue and includes a first set of one or more engagement structures. For example, the cylindrical body may be secured in an opening of an armrest of a seat. An annular identification component is provided that has visual indicia corresponding to the seat location within the venue. The annular identification component has a second set of one or more engagement structures that are configured to mate with the first set of one or more engagement structures. The first set of one or more engagement structures and second set of one or more engagement structures are configured to releasably secure the identification component to the flange. The visual indicia of the annular identification component is translucent and positioned for illumination by the at least one lighting element when the annular identification component is secured to the flange.

Another general aspect of the disclosure includes an apparatus for identifying a seat location in a venue having an annular base with an opening defined by an upstanding lip. The annular base may be configured to facilitate securement of the annular base with a fixed object proximate the seat location in the venue, such as the arm rest of the seat. The annular base includes a first set of engagement structures. The apparatus also includes an annular identification component having visual indicia corresponding to the seat location. The annular identification component has a peripheral wall configured for insertion in the opening of the annular base. Further, the annular identification component includes a second set of engagement structures configured to mate with the first set of engagement structures, where the first set of engagement structures and second set of engagement structures are configured to releasably secure the identification component within the opening of the annular base.

### BRIEF DESCRIPTION OF THE DRAWINGS

FIG. 1 shows a plurality of seats, where each of the illustrated seats includes an apparatus for identifying the location of the seat in the venue.

FIG. 2 is a perspective view of one example of a seat marker along with various cords/connectors that may be used to facilitate connection of the seat marker to a source of electrical power.

FIG. 3 is an exploded view of one example of the seat marker.

FIG. 4 is a top view of the seat marker with the identification component removed.

FIG. 5 is a schematic diagram of the electronic components of the printed circuit board.

FIG. 6 is a top view of one example of the identification component.

FIG. 7 is a bottom perspective view of the identification component.

FIG. 8 is a perspective view of the underside of the seat marker with the cylindrical base and identification component secured with one another using the clips and clip openings.

FIG. 9 is a cross-sectional view of one example of the seat marker engaged in an armrest of a seat.

FIG. 10 shows an alternative structure on the identification component that may be used to releasably secure the identification component with the cylindrical base.

FIG. 11 shows an alternative structure on the cylindrical base that may be used with the structure shown in FIG. 10 to form a twist lock arrangement to releasably secure the identification component with the cylindrical base.

### DETAILED DESCRIPTION

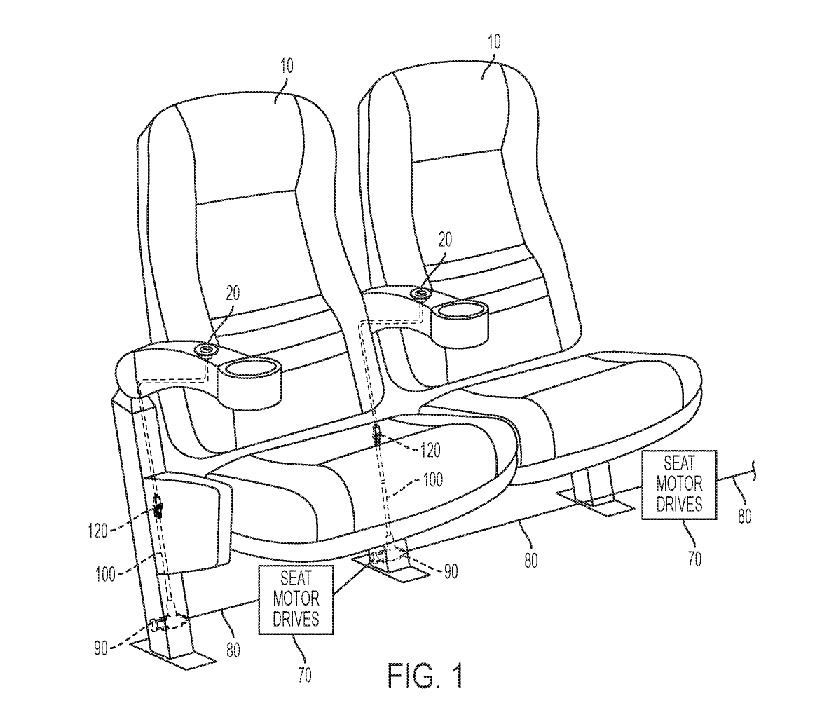

FIG. 1 shows a plurality of adjacent seats 10, where each of the illustrated seats includes an apparatus for identifying the location of the seat in the venue. In this example, each of the illustrated apparatus is in the form of a seat marker 20 located proximate a respective seat. Although the seat markers may be placed at various locations proximate their respective seats, the arrangement of FIG. 1 shows the seat markers 20 fixed to the armrests 30.

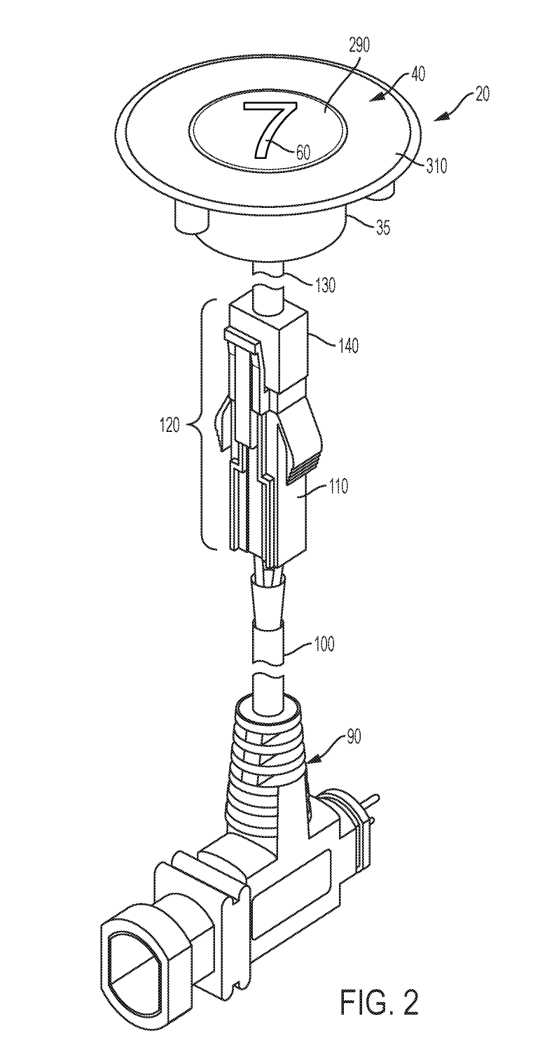

In one example, the seat markers 20 are configured for use in a low light environment. To this end, each of the illustrated seat markers 20 may include one or more illumination elements, such as light-emitting diodes. FIG. 2 is a perspective view of one example of the seat marker 20 along with various cords and connectors that may be used to facilitate connection of the seat marker 20 to a source of electrical power to light up the illumination elements. As will be discussed in further detail below, the light-emitting elements are disposed in a base 35 of the seat marker 20, and are positioned to direct the emitted light through selected portions of an identification component 40. Here, the identification component 40 includes a central disc 290 with a translucent portion 60 in the shape of a number (or other indicia) identifying the corresponding seat with which the seat marker 20 is associated.

In FIG. 1, each of the illustrated seats 10 includes one or more seat motor drives 70 that may be controlled by the user to adjust the disposition of various portions of the seat (i.e., lumbar support, recline angle, etc.) The seat motor drives 70 may receive operating power from a power bus 80. In the disclosed arrangement, the power bus 80 is also used to provide power to the illumination elements of the individual seat markers 20 through a power cable assembly. In the power cable assembly shown here, at least one breakout connector 90 is placed in line with the power bus 80 between the seat motor drives 70 of, for example, adjacent seats 10. A breakout cord 100 extends from the breakout connector 90 and terminates at a first half 110 of a releasable connector 120, such as a snap-fit connector. A power cord 130 extends from the seat marker 20 and is used to provide electrical power to the illumination elements. In this example, power cord 130 terminates at a second half 140 of the releasable connector 120 to complete a circuit that provides electrical power from the power bus 80 to the illumination elements of the respective seat marker 20. Alternatively, the power cord 130 may terminate at the breakout connector 90 without the intermediate releasable connector 120. Other power cable assemblies may also be used to provide electrical power to the seat marker.

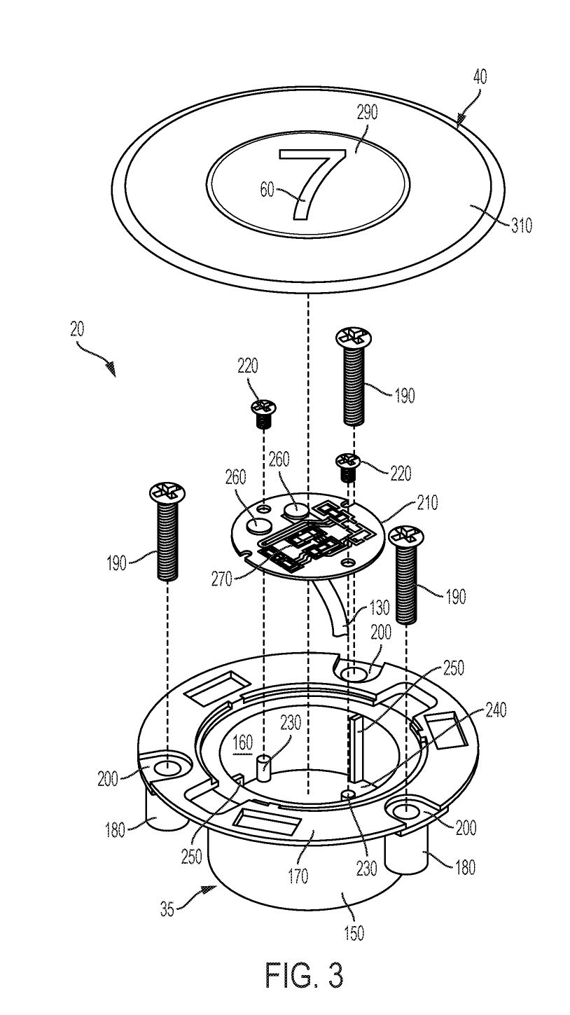

FIG. 3 is an exploded view of one example of the seat marker 20. Here, the base 35 includes a cylindrical body 150 having an open end and a sidewall 160 defining a hollow interior. A flange 170 is secured with the cylindrical body 150 proximate the open end. The flange 170 and cylindrical body 150 may be molded as a single piece in which the flange 170 substantially surrounds the open end as shown in FIG. 3.

The flange 170 is configured to secure the cylindrical body 150 with a fixed object (i.e. armrest 30) located proximate the seat location in the venue. To this end, a plurality of hollow shafts 180 extend from a lower surface of the flange 170. Here, a total of three hollow shafts 180 are used, but that number may be increased or decreased depending on the particular manner in which the cylindrical body 150 is to be secured within the opening of the fixed object. Each of the illustrated hollow shafts 180 has a length sufficient to accept respective fasteners 190 therethrough while also allowing the fasteners 190 to extend into engagement with the corresponding the securement structures of the fixed object. The upper surface of the flange 170 proximate each hollow shaft 180 may include a recess 200 to set the heads of the fasteners 190 below the very top surface of the flange 170 and prevent interference with the mechanical connection to the identification component 40.

FIG. 4 is a top view of the seat marker 20 with the identification component 40 removed. With reference to both FIG. 3 and FIG. 4, it can be seen that a printed circuit board 210 is supported in the hollow interior of the cylindrical body 150. In this example, the printed circuit board 210 is held within the hollow interior using securements 220 that attach the outer portion of the printed circuit board 210 to corresponding posts 230 extending from a bottom surface 240 of the cylindrical body 150. Rails 250 extend inwardly from the sidewall 160 to ensure proper orientation of the printed circuit board 210 within the hollow interior during assembly of the seat marker 20. Further, the rails 250 may be used to assist in preventing rotation of the printed circuit board 210 once it is seated with the cylindrical body 150.

The printed circuit board 210 is connected at terminals 260, 265 to the conductors of power cord 130. A light-emitting diode 270 is disposed at a central portion of the printed circuit board 210 and is located to provide illumination of the translucent portion 60. Other electronic components may also be included on the printed circuit board 210 between the terminals 260, 265 and light-emitting diode 270. For example, the electrical power from the power bus 80 is often unfiltered and can be contaminated with electrical noise from the seat motor drives 70. This can lead to flickering and/or burnout of the light-emitting diode 270. In such instances, the printed circuit board 210 may include a voltage regulator electrically disposed between the terminals 260 and the light-emitting diode 270.

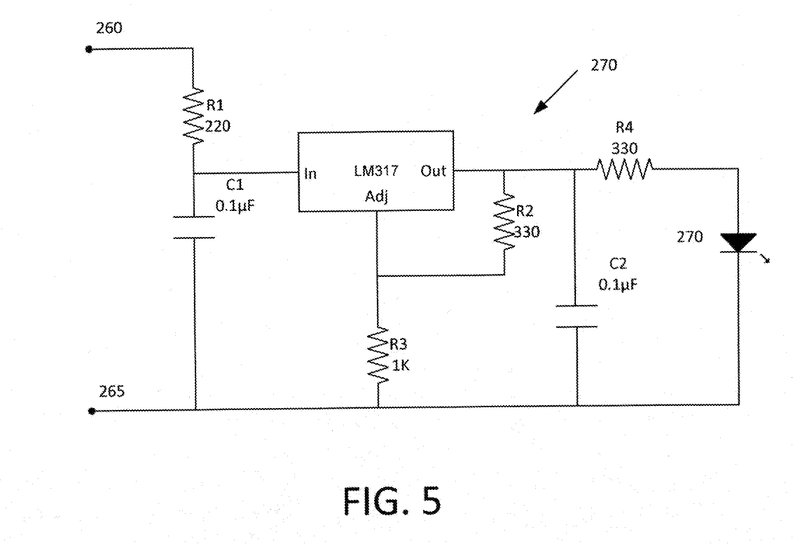

FIG. 5 is a schematic diagram of the electronic components of the printed circuit board 210. In this example, power from terminals 260, 265 is provided to light-emitting diode 270 through a voltage regulation circuit 280. The voltage regulation circuit 280 may be based, for example, on an LM317M integrated circuit. The LM317M is a three-terminal adjustable positive voltage regulator capable of supplying in excess of 500 mA over an output voltage range of 1.2 V to 37 V. The values shown for R1-R4, C1, and C2 are exemplary and may be used in connection with standard voltages on a typical power bus 80 of, for example, a theater venue.

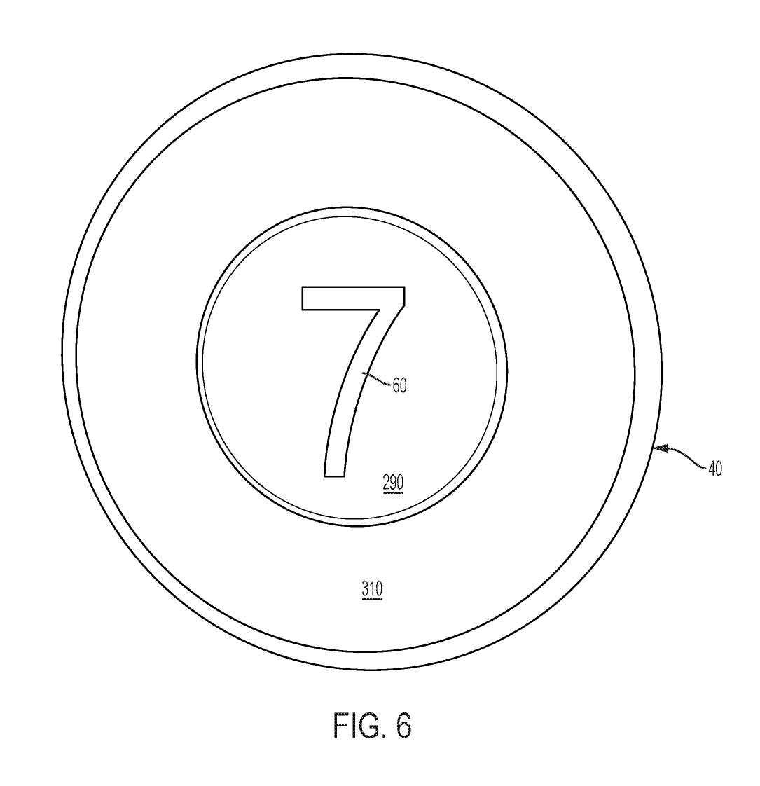

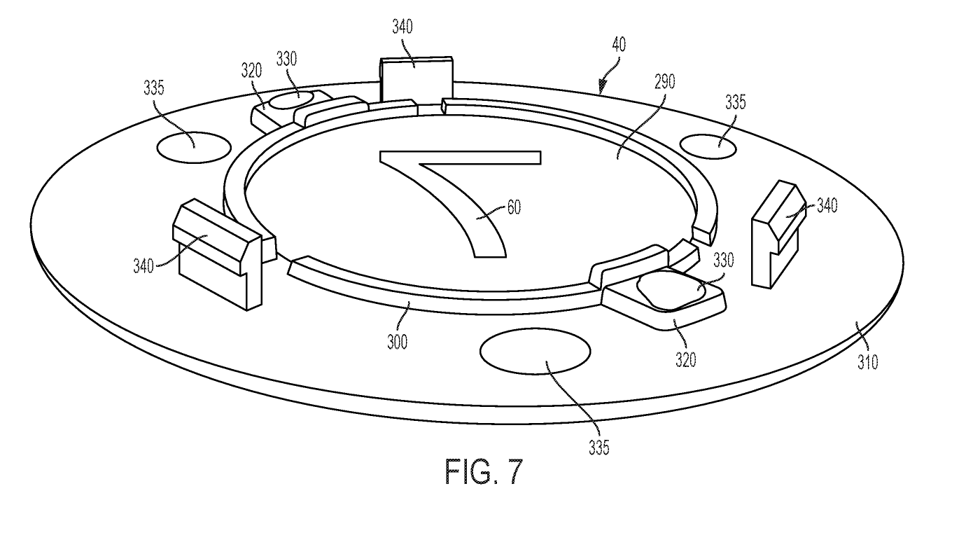

FIG. 6 is a top view of one example of the identification component 40 while FIG. 7 is a bottom perspective view of the same. In this example, the identification component 40 includes a central disc 290 having a boss 300 that is configured to fit within an annular opening of an annular frame 310. The thickness of the central disc 290 may be such that its upper surface is generally even with the upper surface of the annular frame 310.

As shown, the central disc 290 may include one or more ears 320 configured to secure the central disc 290 within the opening of the frame 310. To this end, the ears 320 may include openings to receive corresponding posts 330 extending from the bottom of the frame 310. During manufacturing, the posts 330 extend through and beyond the openings of the ears 320, after which the posts 330 are melted to fix the central disc 290 to the frame 310. FIG. 7 shows the posts 330 after they have been melted. Additionally, FIG. 7 shows a plurality of recessed areas 335 that align with fasteners 190 (FIG. 3) so that the bottom surface of the identification component 40 may lie flat with the upper surface of the flange 170.

The identification component 40 includes a set of engagement structures that fasten with a corresponding set of engagement structures on the cylindrical base 35. Here, the engagement structures on the identification component 40 are in the form of clips 340 extending from the bottom of the frame 310. With reference again to FIG. 4, the engagement structures of the cylindrical base 35 are in the form of clip openings 350 that are configured to receive the clips 340 in a cantilever snap fit arrangement. Three clips 340 and three clip openings 350 are arranged at 120° with respect to one another, but other configurations may also be used. Together, the clips 340 and clip openings 350 allow the identification component 40 and the cylindrical base 35 to be releasably secured with one another. Among other things, this allows identification components having different visual indicia to be readily swapped between different bases 35, even after the seat marker 20 has been assembled and/or fixed at the desired location in the venue.

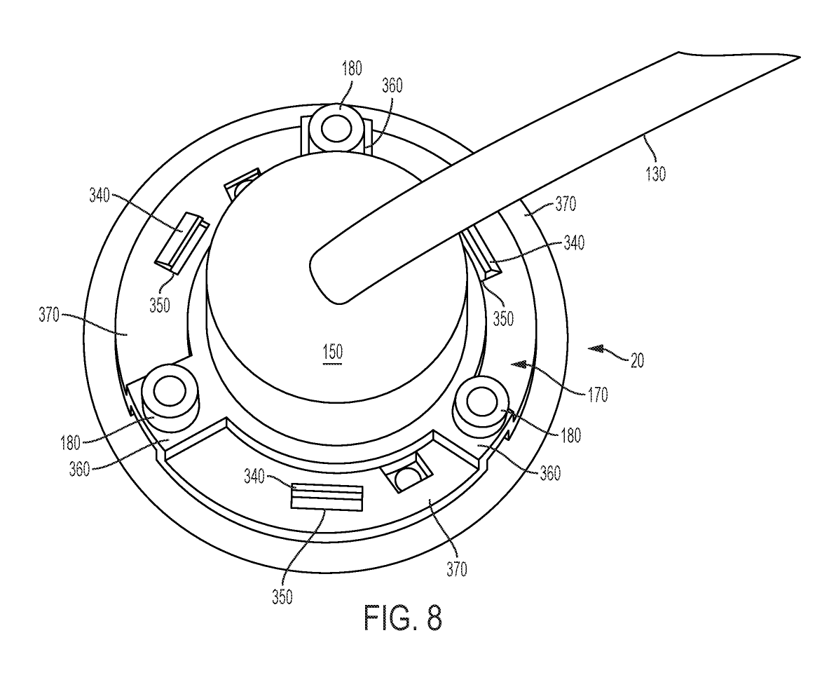

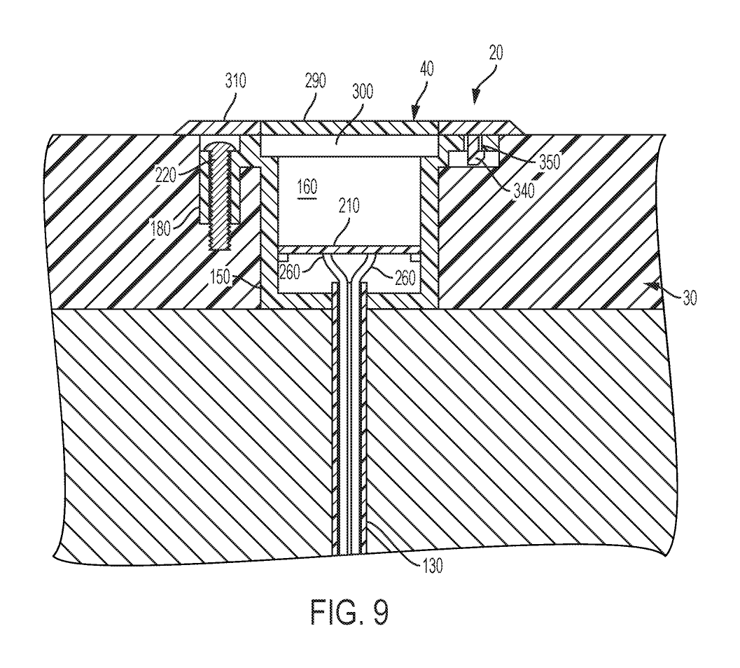

FIG. 8 is a perspective view of the underside of the seat marker 20 with the cylindrical base 35 and identification component 40 secured with one another using the clips 340 and clip openings 350. In this example, each of the illustrated hollow shafts 180 extends from a respective raised platform 360. A plurality of generally flat areas 370 extend between the raised platforms 360. The end of each illustrated clip 340 extends above each of the generally flat areas 370 but remains below the height of the raised platforms 360. When attached to a seat, the hollow shafts 180 and corresponding fasteners 190 may be driven against, for example, the leather or frame of the seat. However, the raised platforms 360 limit the depth to which they may be driven so as to protect the clips 340 from being damaged and/or pinned between the flange 170 and the leather or frame of the seat. This allows room for removal of the clips 340 from the clip openings 350 so that the identification component 40 may be attached, removed, or replaced once the seat marker 20 has been affixed to the seat. One example of the cooperation of the structures is shown in FIG. 9, which is a cross-sectional view of the seat marker 20 attached to the armrest 30 of the respective seat.

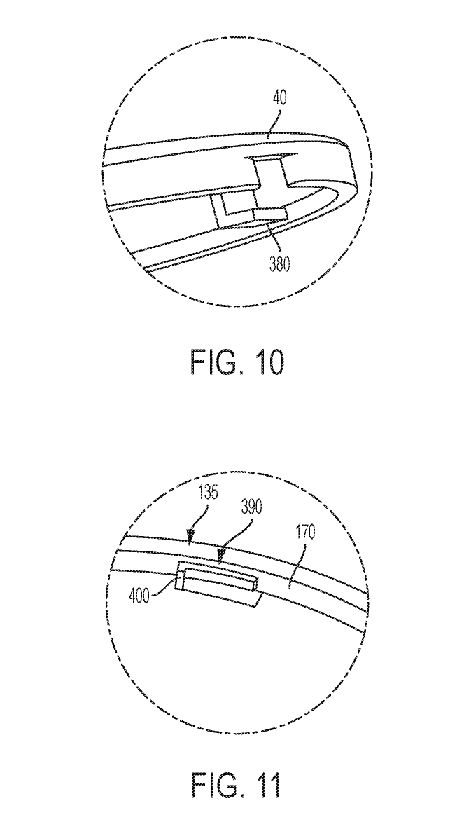

FIG. 10 and FIG. 11 show a twist clip fitting arrangement that may be used to releasably secure the identification component 40 with the cylindrical base 35. Here, the identification component 40 includes a plurality of L-shaped projections 380, and the flange 170 includes corresponding undercuts 390. In securing the identification component 40 with the cylindrical base 135, the identification component 40 and cylindrical base and with 35 are brought against one another with the L-shaped projections 380 initially displaced from their corresponding undercuts 390. The identification component 40 is then rotated so that the L-shaped projections 380 are driven into the slots formed by the undercuts 390, which are dimensioned to secure them with respect to one another by friction. Each of the illustrated undercuts 390 has a terminal wall 400 that limits the degree of rotation of the identification component 40. The identification component 40 is considered secured with the cylindrical base 35 once the edges of the L-shaped projections 380 are driven into the slots and engage the terminal walls 400.

It will be appreciated that the foregoing disclosure provides examples of at least one system and technique that may be used to implement the apparatus. However, it is contemplated that other implementations of the apparatus may differ in detail from the foregoing examples. All references to the apparatus or examples thereof are intended to reference the particular example being discussed at that point and are not intended to imply any limitation as to the scope of the invention more generally. All language of distinction and disparagement with respect to certain features is intended to indicate a lack of preference for those features, but not to exclude such from the scope of the invention entirely unless otherwise indicated.

1. An apparatus for identifying a seat in a venue, the apparatus comprising:
a cylindrical base having an open end and a sidewall defining a hollow interior, wherein the cylindrical base is configured for securement within an opening of the seat, the cylindrical base further having a first set of one or more engagement structures;
a printed circuit board supported in the hollow interior of the cylindrical base and having at least one light-emitting diode, the printed circuit board further having a voltage regulator configured for providing power to the at least one light-emitting diode; and
an identification component having visual indicia for identifying the seat within the venue, the identification component having a second set of one or more engagement structures configured to mate with the first set of one or more engagement structures, wherein the first set of one or more engagement structures and second set of one or more engagement structures are configured to releasably secure the identification component to the cylindrical base, and wherein the visual indicia of the identification component is translucent and positioned for illumination by the at least one light-emitting diode when the identification component is secured to the cylindrical base.

2. The apparatus of claim 1, further comprising:
a power cable configured to provide electrical power to the printed circuit board, wherein the power cable extends to an exterior of the cylindrical base and terminates at a power connector.

3. The apparatus of claim 1, wherein the cylindrical base is configured to be fastened within an opening of an armrest of a respective venue seat.

4. The apparatus of claim 1, further comprising:
a power cable assembly configured to provide power from a power bus to the printed circuit board, wherein the power bus is further configured to provide power to multiple seats of the venue.

5. The apparatus of claim 4, wherein the power bus provides power to seat adjustment systems in the multiple seats of the venue.

6. The apparatus of claim 1, wherein the first set of one or more engagement structures and second set of one or more engagement structures are configured to engage one another in a cantilever snap fit arrangement.

7. The apparatus of claim 1, wherein the first set of one or more engagement structures and second set of one or more engagement structures form a clip lock fitting arrangement.

8. An apparatus for identifying a seat location in a venue, the apparatus comprising:
a cylindrical body having an open end and a sidewall defining a hollow interior;
a printed circuit board supported in the hollow interior and having at least one lighting element;
a flange secured with the cylindrical body and surrounding the open end, the flange being configured to secure the cylindrical body within an opening of a fixed object located proximate the seat location in the venue, the flange further having a first set of one or more engagement structures; and
an annular identification component having visual indicia corresponding to the seat location within the venue, the annular identification component having a second set of one or more engagement structures configured to mate with the first set of one or more engagement structures, wherein the first set of one or more engagement structures and second set of one or more engagement structures are configured to releasably secure the identification component to the flange, and wherein the visual indicia of the annular identification component is translucent and positioned for illumination by the at least one lighting element when the annular identification component is secured to the flange.

9. The apparatus of claim 8, wherein the lighting element includes a light emitting diode.

10. The apparatus of claim 9, wherein the printed circuit board includes a voltage regulator.

11. The apparatus of claim 8, further comprising:
a power cord configured to provide electrical power to the printed circuit board, wherein the power cord extends to an exterior of the cylindrical body and terminates at a power plug.

12. The apparatus of claim 8, wherein the cylindrical body is configured to be fastened within an opening of a respective venue seat.

13. The apparatus of claim 8, wherein the cylindrical body is configured to be fastened within an opening of an armrest of a respective venue seat.

14. The apparatus of claim 12, further comprising:
a power cord having a first end electrically connected to the printed circuit board to provide power for the at least one lighting element, the power cord further having a second end terminating at a power plug, wherein the power plug is further configured for connection to a power bus providing power to multiple seats of the venue.

15. The apparatus of claim 14, wherein the power bus provides power to seat adjustment systems in the multiple seats of the venue.

16. The apparatus of claim 15, wherein the at least one lighting element includes a light-emitting diode, and wherein the printed circuit board includes a voltage regulator electrically configured between the power cord and the light-emitting diode.

17. The apparatus of claim 8, wherein the first set of one or more engagement structures and second set of one or more engagement structures are configured to engage one another in a snap fit arrangement.

18. The apparatus of claim 8, wherein the first set of one or more engagement structures and second set of one or more engagement structures are configured to engage one another in a cantilever snap fit arrangement.

19. The apparatus of claim 8, wherein the first set of one or more engagement structures and second set of one or more engagement structures form a twist clip fitting arrangement.

20. An apparatus for identifying a seat location in a venue, the apparatus comprising:
an annular base having an opening defined by an upstanding lip, the annular base being configured to facilitate securement of the annular base with a fixed object proximate the seat location in the venue, the annular base further having a first set of engagement structures; and
an annular identification component having visual indicia corresponding to the seat location, the annular identification component having a peripheral wall configured for insertion in the opening of the annular base, the annular identification component further having a second set of engagement structures configured to mate with the first set of engagement structures, wherein the first set of engagement structures and second set of engagement structures are configured to releasably secure the identification component within the opening of the annular base.
